(19) United States
(12) Patent Application Publication
(10) Pub. No.: US 2024/0072246 A1
(43) Pub. Date: Feb. 29, 2024

(54) ANODES HAVING DUAL LAYERS FOR USE IN LITHIUM ION BATTERIES

(71) Applicant: Apple Inc., Cupertino, CA (US)

(72) Inventors: OuJung Kwon, Cupertino, CA (US); Hyea Kim, Campbell, CA (US); Xianyu Li, Mountain View, CA (US)

(21) Appl. No.: 18/446,310

(22) Filed: Aug. 8, 2023

Related U.S. Application Data
(60) Provisional application No. 63/401,345, filed on Aug. 26, 2022.

(51) Int. Cl. H01M 4/36; H01M 4/134; H01M 4/38; H01M 4/587; H01M 4/62; H01M 4/66

(52) U.S. Cl. CPC H01M 4/366; H01M 4/134; H01M 4/386; H01M 4/587; H01M 4/623; H01M 4/661; H01M 2004/027

(57) ABSTRACT

This disclosure relates generally to battery cells, and more particularly, anode active materials including two layers, for use in lithium ion battery cells.

### PRIORITY

This patent application claims the benefit of U.S. Provisional Patent Application No. 63/401,345, entitled “Anodes Having Dual Layers For Use In Lithium Ion Batteries,” filed Aug. 26, 2022, which is incorporated herein by reference in its entirety.

### FIELD

This disclosure relates generally to battery cells, and more particularly, anodes having a two layer anode active material for use in lithium ion battery cells.

### BACKGROUND

Lithium ion (Li-ion) batteries are widely used as the power sources in consumer electronics. Consumer electronics need Li-ion batteries which can deliver higher volumetric energy densities and sustain more discharge-charge cycles.

### SUMMARY

In a first aspect, the disclosure is directed to anode including an anode current collector, a first layer disposed on the anode current collector, and a second layer disposed on the first layer. The first layer comprising silicon, and the second layer comprising graphite. Together, the first layer and second layer can be considered the anode active material.

In some variations, the anode current collector includes copper or nickel. In some variations, the anode current collector is copper, such as a copper foil. In some variations, the anode current collector is nickel, such as a nickel foil. In some variations, the anode current collector is a carbon-coated copper foil. In some variations, the anode current collector is a carbon-coated nickel foil. In some variations, the first layer can be 5 wt %-60 wt % of the total wt % of the first layer and second layer. In some variations, the first layer is 10 wt %-30 wt % of the total wt % of the first layer and second layer. In further variations, first layer is 15 wt %-25 wt % of the total wt % of the first layer and second layer.

In a second aspect, the first layer includes a first binder. In some variations, the first binder is in an amount of 5 wt %-15 wt % of the first layer. In some variations, the first binder is selected from Polyacrylic acid (PAA), a Polyimide (PI), a Polyvinylidene fluoride (PVdF), a Polyvinyl alcohol (PVA), a Polyacrylonitrile (PAN), a Polyethylene imine (PI), a polyurethane (PU), a derivative thereof, a copolymer thereof, and a combination thereof. In further variations, the first binder is a polyurethane. The first layer can also include carboxy methylcellulose (CMC). In still further variations, the first layer can include carbon nanotubes. In still further variations, the first layer can include carbon black.

In a third aspect, the second layer includes a second binder. In some variations, the second binder is in an amount from 1 wt % to 10 wt %. In some variations, the second binder is selected from styrene-butadiene rubber (SBR), CMC, and a combination of both SBR and CMC. In further variations, the second binder is a combination of SBR and CMC. In some variations, the SBR is in an amount from 0.5 wt %-5 wt %. In some variations, the CMC in an amount from 0.5 wt %-5 wt %. In further variations, the second layer comprises carbon black.

In a fourth aspect, the battery cell includes a cathode having a cathode active material disposed on a cathode current collector, and anode described herein, a separator disposed between the cathode and anode, and an electrolyte fluid disposed between the cathode and anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a side view of a set of layers for a battery cell in accordance with an illustrative embodiment;

FIG. 3A is a side view of an anode including an anode current collector, a first layer including silicon-containing active material disposed on the anode current collector, and a second layer including graphite disposed on the first layer, in accordance with illustrative embodiments;

FIG. 3B is a side view of a copper foil anode current collector and a single layer including both silicon-containing active material and graphite disposed on the anode current collector, in accordance with illustrative embodiments;

FIG. 4 depicts cycle performance of an anode having a first silicon-containing layer disposed on the anode and a second graphite-containing layer disposed on the silicon-containing layer, as compared to silicon and graphite combined in a single layer, in accordance with illustrative embodiments;

FIG. 5A depicts a scanning electron microscope (SEM) image of a first silicon-containing layer disposed on a copper anode current collector and a second graphite-containing layer disposed on the silicon-containing layer, in accordance with illustrative embodiments;

FIG. 5B depicts an SEM image of an anode including an anode current collector, and a single layer including both silicon and graphite disposed on the anode current collector, in accordance with illustrative embodiments;

FIG. 6A depicts an SEM image of a graphite-containing layer without any silicon-containing particles, in accordance with illustrative embodiments;

FIG. 6B depicts an SEM image of a single layer combining both graphite and silicon-containing particles, in accordance with illustrative embodiments;

FIG. 7A depicts a scanning electron microscope image of carbon nanotube particles disposed in a single layer of silicon-containing active material, in accordance with illustrative embodiments;

FIG. 7B depicts a scanning electron microscope image of carbon nanotube particles disposed in a combined silicon and graphite-containing layer, in accordance with illustrative embodiments;

FIG. 8A depicts capacity retention as a function of cycle count of two batteries: the first with an anode having a first silicon-containing layer disposed on the anode and a second graphite-containing layer disposed on the silicon-containing layer, and the second having a single layer of combined silicon and graphite disposed on the anode, in accordance with illustrative embodiments;

FIG. 8B depicts capacity retention as a function of cycle count of two batteries: the first with an anode having a first silicon-containing layer disposed on the anode and a second graphite-containing layer disposed on the silicon-containing layer, and the second having a single layer of combined silicon and graphite disposed on the anode, in accordance with illustrative embodiments; and

FIG. 9 shows the discharge capacity over 100 cycles count for three batteries: battery 902 having with an anode having a first silicon-containing layer disposed on the anode and a second graphite-containing layer disposed on the silicon-containing layer, battery 904 having a silicon-containing layer only, and battery 906 having a graphite layer only, in accordance with illustrative embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The disclosure is directed to an anode including an anode current collector, a first layer disposed on the anode current collector, and a second layer disposed on the first layer. The first layer includes silicon (also referred to herein as a “silicon-containing layer”). The silicon can also be referred to as a “silicon-containing active material”. The second layer includes graphite (also referred to herein as a “graphite-containing layer”).

In certain variations, the first layer disposed on the anode current collector is the graphite-containing layer, and the second layer is the silicon-containing layer. In such variations, the graphite-containing layer can include any additional components in any quantity as described in graphite-containing layers herein. Likewise, silicon-containing layer can include any components in any quantity as described herein.

Different layers for silicon and graphite can include different binders. In various aspects, the binder can help maintain contact between particles, allowing increased electrical conductivity. In variations, binders in silicon-containing layers can have stronger adhesion/cohesion than binders in graphite-containing layers. Further, silicon-containing layers can include larger quantity of binder than graphite-containing layers.

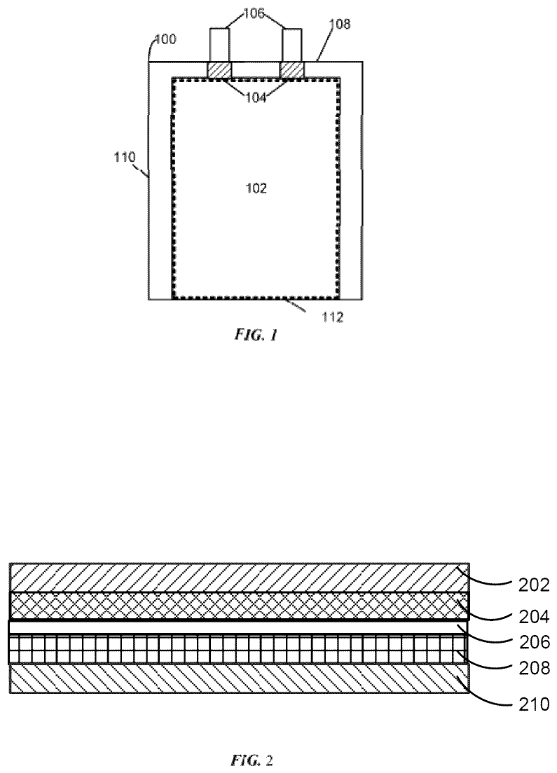

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil, nickel foil, copper foil coated with carbon, or nickel foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be rolled into a wound configuration (e.g., a “jelly roll”). An electrolyte solution is disposed between each cathode and anode.

During assembly of the battery cell 100, the stack 102 can be enclosed in a container such as a pouch or hard container. The stack 102 may be in a planar or wound configuration, although other configurations are possible. In some variations, the container can be a pouch. In such variations, the pouch is flexible sheet folded along a fold line 112. In various aspects, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both. In other variations, the container is a metallic container, that can be welded along seams.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

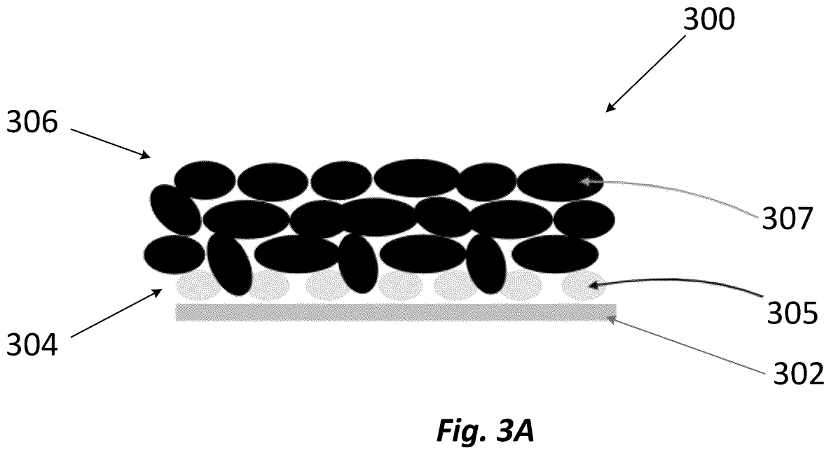

FIG. 2 presents a perspective view of battery cell 200 (e.g., the battery cell 100 of FIG. 1) in accordance with the disclosed embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210, and is in contact with separator 208. To create the battery cell, cathode 202, separator 208, and anode 210 may be stacked in a planar configuration, or stacked and then wrapped into a wound configuration. Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil.

The cathode active material can be any material known in the art. For example, the cathode active material can be any cathode active material described in U.S. Pat. No. 10,297,823, which is incorporated herein by reference in its entirety. By way of further example, the compound can be any one of the compounds of Formula (Ia)-Formula (VIIIb) of U.S. Pat. No. 10,297,823, incorporated herein by reference.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). However, other microporous polymer membranes or non-woven fabric mats are possible (e.g., gel polymer electrolytes). In some variations, the separator can be a separator such as that disclosed in U.S. Pat. No. 10,153,474, incorporated by reference herein in its entirety.

In general, separators represent structures in a battery, such as interposed layers, that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, electrolyte fluid can act a conductive pathway for the movement of cations passing from the negative to the positive electrodes during discharge. The electrolyte fluid can include any electrolyte fluid known in the art. In various aspects, the electrolyte fluid can be an electrolyte fluid described in for example, U.S. patent application Ser. No. 17/865,991, incorporated herein by reference in its entirety.

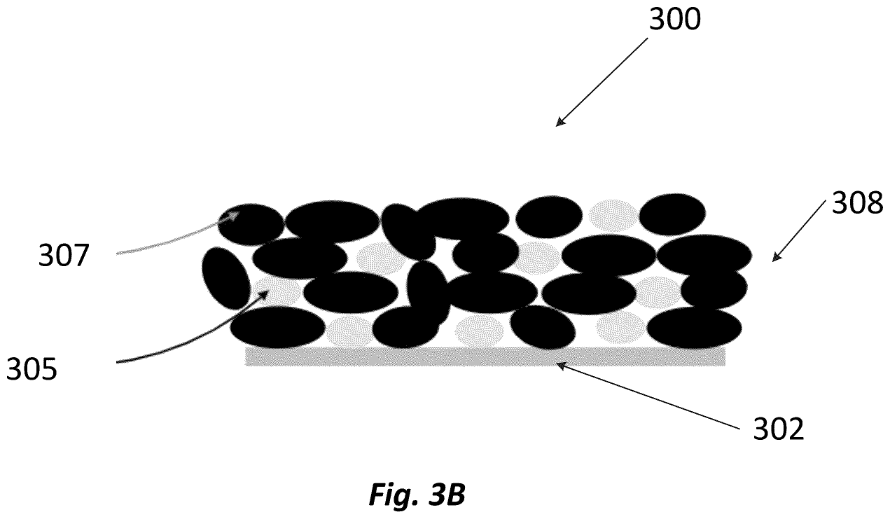

FIG. 3A is a side view of anode 300. Anode 300 includes anode current collector 302. A first layer 304 including silicon 305 is disposed on anode current collector 302. A second layer 306 including graphite 307 is disposed on first layer 304. By contrast, FIG. 3B depicts a side view of an anode including an anode current collector 302, and a single layer 308 including both silicon 305 and graphite 307 disposed on the anode current collector 302.

In various aspects, the silicon-containing layer and graphite-containing layer can be present in a wt % ratio. In some variations, silicon-containing layer is equal to or less than 60 wt % of the total wt % of the two layers. In some variations, silicon-containing layer is equal to or less than 55 wt % of the total wt % of the two layers. In some variations, silicon-containing layer is equal to or less than 50 wt % of the total wt % of the two layers. In some variations, silicon-containing layer is equal to or less than 45 wt % of the total wt % of the two layers. In some variations, silicon-containing layer is equal to or less than 40 wt % of the total wt % of the two layers. In some variations, silicon-containing layer is equal to or less than 35 wt % of the total wt % of the two layers. In some variations, silicon-containing layer is equal to or less than 30 wt % of the total wt % of the two layers. In some variations, silicon-containing layer is equal to or less than 25 wt % of the total wt % of the two layers. In some variations, silicon-containing layer is equal to or less than 20 wt % of the total wt % of the two layers. In some variations, silicon-containing layer is equal to or less than 15 wt % of the total wt % of the two layers. In some variations, silicon-containing layer is equal to or less than 10 wt % of the total wt % of the two layers.

In some variations, the silicon-containing layer is at least 5 wt % of the total wt % of the two layers. In some variations, the silicon-containing layer is at least 10 wt % of the total wt % of the two layers. In some variations, the silicon-containing layer is at least 15 wt % of the total wt % of the two layers. In some variations, the silicon-containing layer is at least 20 wt % of the total wt % of the two layers. In some variations, the silicon-containing layer is at least 25 wt % of the total wt % of the two layers. In some variations, the silicon-containing layer is at least 30 wt % of the total wt % of the two layers. In some variations, the silicon-containing layer is at least 35 wt % of the total wt % of the two layers. In some variations, the silicon-containing layer is at least 40 wt % of the total wt % of the two layers. In some variations, the silicon-containing layer is at least 45 wt % of the total wt % of the two layers. In some variations, the silicon-containing layer is at least 50 wt % of the total wt % of the two layers. In some variations, the silicon-containing layer is at least 55 wt % of the total wt % of the two layers.

In some variations, the graphite-containing layer is at least 30 wt % of the total wt % of the two layers. In some variations, the graphite-containing layer is at least 35 wt % of the total wt % of the two layers. In some variations, the graphite-containing layer is at least 40 wt % of the total wt % of the two layers. In some variations, the graphite-containing layer is at least 45 wt % of the total wt % of the two layers. In some variations, the graphite-containing layer is at least 50 wt % of the total wt % of the two layers. In some variations, the graphite-containing layer is at least 55 wt % of the total wt % of the two layers. In some variations, the graphite-containing layer is at least 60 wt % of the total wt % of the two layers. In some variations, the graphite-containing layer is at least 65 wt % of the total wt % of the two layers. In some variations, the graphite-containing layer is at least 70 wt % of the total wt % of the two layers. In some variations, the graphite-containing layer is at least 75 wt % of the total wt % of the two layers. In some variations, the graphite-containing layer is at least 80 wt % of the total wt % of the two layers. In some variations, the graphite-containing layer is at least 85 wt % of the total wt % of the two layers. In some variations, the graphite-containing layer is at least 90 wt % of the total wt % of the two layers.

In some variations, graphite-containing layer is equal to or less than 95 wt % of the total wt % of the two layers. In some variations, graphite-containing layer is equal to or less than 90 wt % of the total wt % of the two layers. In some variations, graphite-containing layer is equal to or less than 85 wt % of the total wt % of the two layers. In some variations, graphite-containing layer is equal to or less than 80 wt % of the total wt % of the two layers. In some variations, graphite-containing layer is equal to or less than 75 wt % of the total wt % of the two layers. In some variations, graphite-containing layer is equal to or less than 70 wt % of the total wt % of the two layers. In some variations, graphite-containing layer is equal to or less than 65 wt % of the total wt % of the two layers. In some variations, graphite-containing layer is equal to or less than 60 wt % of the total wt % of the two layers. In some variations, graphite-containing layer is equal to or less than 55 wt % of the total wt % of the two layers. In some variations, graphite-containing layer is equal to or less than 50 wt % of the total wt % of the two layers. In some variations, graphite-containing layer is equal to or less than 45 wt % of the total wt % of the two layers. In some variations, graphite-containing layer is equal to or less than 40 wt % of the total wt % of the two layers. In some variations, graphite-containing layer is equal to or less than 35 wt % of the total wt % of the two layers.

In some variations, the silicon-containing layer is from 15-25 wt % of the total wt of the two layers, and the graphite-containing layer is from 75 wt % to 85 wt % of the two layers.

The layers can also have a thickness in a range.

In some variations, the silicon-containing layer is at least 4 μm thick. In some variations, the silicon-containing layer is at least 8 μm thick. In some variations, the silicon-containing layer is at least 10 μm thick. In some variations, the silicon-containing layer is at least 15 μm thick. In some variations, the silicon-containing layer is at least 20 μm thick. In some variations, the silicon-containing layer is at least 25 μm thick. In some variations, the silicon-containing layer is at least 30 μm thick. In some variations, the silicon-containing layer is at least 35 μm thick. In some variations, the silicon-containing layer is at least 40 μm thick. In some variations, the silicon-containing layer is at least 45 μm thick.

In some variations, the silicon-containing layer is less than or equal to 50 μm thick. In some variations, the silicon-containing layer is less than or equal to 45 μm thick. In some variations, the silicon-containing layer is less than or equal to 35 μm thick. In some variations, the silicon-containing layer is less than or equal to 30 μm thick. In some variations, the silicon-containing layer is less than or equal to 25 μm thick. In some variations, the silicon-containing layer is less than or equal to 20 μm thick. In some variations, the silicon-containing layer is less than or equal to 15 μm thick. In some variations, the silicon-containing layer is less than or equal to 10 μm thick. In some variations, the silicon-containing layer is less than or equal to 8 μm thick.

In some variations, the graphite layer is at least 2.5 μm thick. In some variations, the graphite layer is at least 3 μm thick. In some variations, the graphite layer is at least 5 μm thick. In some variations, the graphite layer is at least 10 μm thick. In some variations, the graphite layer is at least 15 μm thick. In some variations, the graphite layer is at least 20 μm thick. In some variations, the graphite layer is at least 30 μm thick. In some variations, the graphite layer is at least 40 μm thick. In some variations, the graphite layer is at least 50 μm thick. In some variations, the graphite layer is at least 60 μm thick. In some variations, the graphite layer is at least 70 μm thick. In some variations, the graphite layer is at least 80 μm thick. In some variations, the graphite layer is at least 90 μm thick. In some variations, the graphite layer is at least 100 μm thick. In some variations, the graphite layer is at least 150 μm thick. In some variations, the graphite layer is at least 200 μm thick. In some variations, the graphite layer is at least 250 μm thick. In some variations, the graphite layer is at least 300 μm thick. In some variations, the graphite layer is at least 350 μm thick. In some variations, the graphite layer is at least 400 μm thick. In some variations, the graphite layer is at least 450 μm thick. In some variations, the graphite layer is at least 500 μm thick. In some variations, the graphite layer is at least 550 μm thick. In some variations, the graphite layer is at least 600 μm thick. In some variations, the graphite layer is at least 650 μm thick. In some variations, the graphite layer is at least 700 μm thick. In some variations, the graphite layer is at least 750 μm thick. In some variations, the graphite layer is at least 800 μm thick. In some variations, the graphite layer is at least 850 μm thick. In some variations, the graphite layer is at least 900 μm thick. In some variations, the graphite layer is at least 950 μm thick.

In some variations, the graphite layer is less than or equal to 1000 μm thick. In some variations, the graphite layer is less than or equal to 950 μm thick. In some variations, the graphite layer is less than or equal to 900 μm thick. In some variations, the graphite layer is less than or equal to 850 μm thick. In some variations, the graphite layer is less than or equal to 800 μm thick. In some variations, the graphite layer is less than or equal to 750 μm thick. In some variations, the graphite layer is less than or equal to 700 μm thick. In some variations, the graphite layer is less than or equal to 650 μm thick. In some variations, the graphite layer is less than or equal to 600 μm thick. In some variations, the graphite layer is less than or equal to 550 μm thick. In some variations, the graphite layer is less than or equal to 500 μm thick. In some variations, the graphite layer is less than or equal to 450 μm thick. In some variations, the graphite layer is less than or equal to 400 μm thick. In some variations, the graphite layer is less than or equal to 350 μm thick. In some variations, the graphite layer is less than or equal to 300 μm thick. In some variations, the graphite layer is less than or equal to 250 μm thick. In some variations, the graphite layer is less than or equal to 200 μm thick. In some variations, the graphite layer is less than or equal to 150 μm thick. In some variations, the graphite layer is 90 than or equal to 80 μm thick. In some variations, the graphite layer is less than or equal to 70 μm thick. In some variations, the graphite layer is less than or equal to 60 μm thick. In some variations, the graphite layer is less than or equal to 55 μm thick. In some variations, the graphite layer is less than or equal to 50 μm thick. In some variations, the graphite layer is less than or equal to 45 μm thick. In some variations, the graphite layer is less than or equal to 30 μm thick. In some variations, the graphite layer is less than or equal to 25 μm thick. In some variations, the graphite layer is less than or equal to 20 μm thick. In some variations, the graphite layer is less than or equal to 15 μm thick. In some variations, the graphite layer is less than or equal to 10 μm thick. In some variations, the graphite layer is less than or equal to 5 μm thick. In some variations, the graphite layer is less than or equal to 3 μm thick.

### Silicon-Containing Layer

The silicon-containing layer can include any silicon compound known in the art. As noted herein, the silicon can also be referred to as a silicon-containing active material. In various non-limiting examples, the silicon can be silicon-carbon composite, silicon monoxide (SiOₓ, also referred to herein as “silicon oxide”), a silicon metal alloy, or a silicon metal oxide. In some variations, the silicon is silicon oxide. The anode active material that includes silicon can achieve a higher specific capacity than without silicon.

The silicon-containing layer can include a binder different from the graphite-containing layer. In some variations, the binder is selected from Polyacrylic acid (PAA), a Polyimide (PI), a Polyvinylidene fluoride (PVdF), a Polyvinyl alcohol (PVA), a Polyacrylonitrile (PAN), a Polyethylene imine (PI), a polyurethane (PU), a derivative thereof, a copolymer thereof, and a combination thereof. In some variations, the binder is selected from Polyacrylic acid (PAA), a Polyimide (PI), a Polyvinylidene fluoride (PVdF), a Polyvinyl alcohol (PVA), a Polyacrylonitrile (PAN), a Polyethylene imine (PI), a polyurethane (PU), and a combination thereof. In some variations, the silicon-containing layer can have a polyurethane binder. In various aspects, the silicon-containing layer can have a polyacrylic acid binder.

In some variations, the silicon-containing layer includes at least 1 wt % binder of the total wt % of the silicon-containing layer. In some variations, the silicon-containing layer includes at least 2 wt % binder of the total wt % of the silicon-containing layer. In some variations, the silicon-containing layer includes at least 3 wt % binder of the total wt % of the silicon-containing layer. In some variations, the silicon-containing layer includes at least 4 wt % binder of the total wt % of the silicon-containing layer. In some variations, the silicon-containing layer includes at least 5 wt % binder of the total wt % of the silicon-containing layer. In some variations, the silicon-containing layer includes at least 6 wt % binder of the total wt % of the silicon-containing layer. In some variations, the silicon-containing layer includes at least 7 wt % binder of the total wt % of the silicon-containing layer. In some variations, the silicon-containing layer includes at least 8 wt % binder of the total wt % of the silicon-containing layer. In some variations, the silicon-containing layer includes at least 9 wt % binder of the total wt % of the silicon-containing layer. In some variations, the silicon-containing layer includes at least 10 wt % binder of the total wt % of the silicon-containing layer. In some variations, the silicon-containing layer includes at least 11 wt % binder of the total wt % of the silicon-containing layer. In some variations, the silicon-containing layer includes at least 12 wt % binder of the total wt % of the silicon-containing layer. In some variations, the silicon-containing layer includes at least 13 wt % binder of the total wt % of the silicon-containing layer. In some variations, the silicon-containing layer includes at least 14 wt % binder of the total wt % of the silicon-containing layer. In some variations, the silicon-containing layer includes at least 15 wt % binder of the total wt % of the silicon-containing layer. In some variations, the silicon-containing layer includes at least 16 wt % binder of the total wt % of the silicon-containing layer. In some variations, the silicon-containing layer includes at least 17 wt % binder of the total wt % of the silicon-containing layer. In some variations, the silicon-containing layer includes at least 18 wt % binder of the total wt % of the silicon-containing layer. In some variations, the silicon-containing layer includes at least 19 wt % binder of the total wt % of the silicon-containing layer.

In some variations, the silicon-containing layer includes less than or equal to 20 wt % binder of the total wt % of the silicon-containing layer. In some variations, the silicon-containing layer includes less than or equal to 19 wt % binder of the total wt % of the silicon-containing layer. In some variations, the silicon-containing layer includes less than or equal to 18 wt % binder of the total wt % of the silicon-containing layer. In some variations, the silicon-containing layer includes less than or equal to 17 wt % binder of the total wt % of the silicon-containing layer. In some variations, the silicon-containing layer includes less than or equal to 16 wt % binder of the total wt % of the silicon-containing layer. In some variations, the silicon-containing layer includes less than or equal to 15 wt % binder of the total wt % of the silicon-containing layer. In some variations, the silicon-containing layer includes less than or equal to 14 wt % binder of the total wt % of the silicon-containing layer. In some variations, the silicon-containing layer includes less than or equal to 13 wt % binder of the total wt % of the silicon-containing layer. In some variations, the silicon-containing layer includes less than or equal to 12 wt % binder of the total wt % of the silicon-containing layer. In some variations, the silicon-containing layer includes less than or equal to 11 wt % binder of the total wt % of the silicon-containing layer. In some variations, the silicon-containing layer includes less than or equal to 10 wt % binder of the total wt % of the silicon-containing layer. In some variations, the silicon-containing layer includes less than or equal to 9 wt % binder of the total wt % of the silicon-containing layer. In some variations, the silicon-containing layer includes less than or equal to 8 wt % binder of the total wt % of the silicon-containing layer. In some variations, the silicon-containing layer includes less than or equal to 7 wt % binder of the total wt % of the silicon-containing layer. In some variations, the silicon-containing layer includes less than or equal to 6 wt % binder of the total wt % of the silicon-containing layer. In some variations, the silicon-containing layer includes less than or equal to 5 wt % binder of the total wt % of the silicon-containing layer. In some variations, the silicon-containing layer includes less than or equal to 4 wt % binder of the total wt % of the silicon-containing layer. In some variations, the silicon-containing layer includes less than or equal to 3 wt % binder of the total wt % of the silicon-containing layer. In some variations, the silicon-containing layer includes less than or equal to 2 wt % binder of the total wt % of the silicon-containing layer.

In some variations, the first layer can include carbon nanotubes (CNTs), a vapor grown carbon fiber (VGCF), graphite (e.g., a conductive graphite), a carbon black, one of each individually, or a combination of two or more of the above.

In some additional variation, carbon nanotubes can be added to the silicon-containing layer. In some variations, the CNTs are single-wall CNTs. In some variations, the CNTs are multi-wall CNTs. In some variations, the CNTs can be a combination of single wall and multi-wall CNTs.

In some variations, CNTs can be at least 0.1 wt % of the silicon-containing layer. In some variations, CNTs can be at least 0.2 wt % of the silicon-containing layer. In some variations, CNTs can be at least 0.3 wt % of the silicon-containing layer. In some variations, CNTs can be at least 0.4 wt % of the silicon-containing layer. In some variations, CNTs can be at least 0.5 wt % of the silicon-containing layer. In some variations, CNTs can be at least 0.6 wt % of the silicon-containing layer. In some variations, CNTs can be at least 0.7 wt % of the silicon-containing layer. In some variations, CNTs can be at least 0.8 wt % of the silicon-containing layer. In some variations, CNTs can be at least 0.9 wt % of the silicon-containing layer.

In some variations, the CNTs can be less than or equal to 1.0 wt % of the silicon-containing layer. In some variations, the CNTs can be less than or equal to 0.9 wt % of the silicon-containing layer. In some variations, the CNTs can be less than or equal to 0.8 wt % of the silicon-containing layer. In some variations, the CNTs can be less than or equal to 0.7 wt % of the silicon-containing layer. In some variations, the CNTs can be less than or equal to 0.6 wt % of the silicon-containing layer. In some variations, the CNTs can be less than or equal to 0.5 wt % of the silicon-containing layer. In some variations, the CNTs can be less than or equal to 0.4 wt % of the silicon-containing layer. In some variations, the CNTs can be less than or equal to 0.3 wt % of the silicon-containing layer. In some variations, the CNTs can be less than or equal to 0.2 wt % of the silicon-containing layer.

In some variations, the silicon-containing layer includes CMC. In some variations, the CMC is at least 0.1 wt % of the silicon-containing layer. In some variations, the CMC is at least 0.2 wt % of the silicon-containing layer. In some variations, the CMC is at least 0.3 wt % of the silicon-containing layer. In some variations, the CMC is at least 0.4 wt % of the silicon-containing layer. In some variations, the CMC is at least 0.5 wt % of the silicon-containing layer. In some variations, the CMC is at least 0.6 wt % of the silicon-containing layer. In some variations, the CMC is at least 0.7 wt % of the silicon-containing layer. In some variations, the CMC is at least 0.8 wt % of the silicon-containing layer. In some variations, the CMC is at least 0.9 wt % of the silicon-containing layer. In some variations, the CMC is at least 1.0 wt % of the silicon-containing layer. In some variations, the CMC is at least 1.1 wt % of the silicon-containing layer. In some variations, the CMC is at least 1.2 wt % of the silicon-containing layer. In some variations, the CMC is at least 1.3 wt % of the silicon-containing layer. In some variations, the CMC is at least 1.4 wt % of the silicon-containing layer.

In some variations, the CMC is less than or equal to 1.5 wt % of the silicon-containing layer. In some variations, the CMC is less than or equal to 1.4 wt % of the silicon-containing layer. In some variations, the CMC is less than or equal to 1.5 wt % of the silicon-containing layer. In some variations, the CMC is less than or equal to 1.2 wt % of the silicon-containing layer. In some variations, the CMC is less than or equal to 1.1 wt % of the silicon-containing layer. In some variations, the CMC is less than or equal to 1.0 wt % of the silicon-containing layer. In some variations, the CMC is less than or equal to 0.9 wt % of the silicon-containing layer. In some variations, the CMC is less than or equal to 0.8 wt % of the silicon-containing layer. In some variations, the CMC is less than or equal to 0.7 wt % of the silicon-containing layer. In some variations, the CMC is less than or equal to 0.6 wt % of the silicon-containing layer. In some variations, the CMC is less than or equal to 0.5 wt % of the silicon-containing layer. In some variations, the CMC is less than or equal to 0.4 wt % of the silicon-containing layer. In some variations, the CMC is less than or equal to 0.3 wt % of the silicon-containing layer. In some variations, the CMC is less than or equal to 0.2 wt % of the silicon-containing layer.

### Graphite-Containing Layer

The graphite-containing layer can include a different binder than the silicon-containing layer. In some variations, the binder is SBR. In some variations, the binder is CMC. In some variations, the binder is a combination of SBR and CMC. Different binders for each active material are used for slurry preparation, and then each material having different binder and/or different amount of binder is coated separately.

In some variations, the wt % SBR is at least 0.5 wt % of the graphite-containing layer. In some variations, the wt % SBR is at least 1.0 wt % of the graphite-containing layer. In some variations, the wt % SBR is at least 2.0 wt % of the graphite-containing layer. In some variations, the wt % SBR is at least 3.0 wt % of the graphite-containing layer. In some variations, the wt % SBR is at least 4.0 wt % of the graphite-containing layer. In some variations, the wt % SBR is at least 5.0 wt % of the graphite-containing layer.

In some variations, the wt % SBR is less than or equal to 6.0 wt % of the graphite-containing layer. In some variations, the wt % SBR is less than or equal to 5.0 wt % of the graphite-containing layer. In some variations, the wt % SBR is less than or equal to 4.0 wt % of the graphite-containing layer. In some variations, the wt % SBR is less than or equal to 3.0 wt % of the graphite-containing layer. In some variations, the wt % SBR is less than or equal to 2.0 wt % of the graphite-containing layer.

In some variations, the wt % CMC is at least 0.1 wt % of the graphite-containing layer. In some variations, the wt % CMC is at least 0.5 wt % of the graphite-containing layer. In some variations, the wt % CMC is at least 1.0 wt % of the graphite-containing layer. In some variations, the wt % CMC is at least 1.3 wt % of the graphite-containing layer. In some variations, the wt % CMC is at least 1.5 wt % of the graphite-containing layer. In some variations, the wt % CMC is at least 1.7 wt % of the graphite-containing layer. In some variations, the wt % CMC is at least 2.0 wt % of the graphite-containing layer. In some variations, the wt % CMC is at least 3.0 wt % of the graphite-containing layer. In some variations, the wt % CMC is at least 4.0 wt % of the graphite-containing layer.

In some variations, the wt % CMC is less than or equal to 5.0 wt % of the graphite-containing layer. In some variations, the wt % CMC is less than or equal to 4.0 wt % of the graphite-containing layer. In some variations, the wt % CMC is less than or equal to 3.0 wt % of the graphite-containing layer. In some variations, the wt % CMC is less than or equal to 2.0 wt % of the graphite-containing layer. In some variations, the wt % CMC is less than or equal to 1.7 wt % of the graphite-containing layer. In some variations, the wt % CMC is less than or equal to 1.3 wt % of the graphite-containing layer. In some variations, the wt % CMC is less than or equal to 1.0 wt % of the graphite-containing layer. In some variations, the wt % CMC is less than or equal to 0.5 wt % of the graphite-containing layer.

In some variations, the wt % of the combination of SBR and CMC is at least 1.0 wt % of the graphite-containing layer. In some variations, the wt % of the combination of SBR and CMC is at least 2.0 wt % of the graphite-containing layer. In some variations, the wt % of the combination of SBR and CMC is at least 3.0 wt % of the graphite-containing layer. In some variations, the wt % of the combination of SBR and CMC is at least 4.0 wt % of the graphite-containing layer. In some variations, the wt % of the combination of SBR and CMC is at least 5.0 wt % of the graphite-containing layer. In some variations, the wt % of the combination of SBR and CMC is at least 6.0 wt % of the graphite-containing layer. In some variations, the wt % of the combination of SBR and CMC is at least 7.0 wt % of the graphite-containing layer. In some variations, the wt % of the combination of SBR and CMC is at least 8.0 wt % of the graphite-containing layer. In some variations, the wt % of the combination of SBR and CMC is at least 9.0 wt % of the graphite-containing layer.

In some variations, the wt % of the combination of SBR and CMC is less than or equal to 10.0 wt % of the graphite-containing layer. In some variations, the wt % of the combination of SBR and CMC is less than or equal to 9.0 wt % of the graphite-containing layer. In some variations, the wt % of the combination of SBR and CMC is less than or equal to 8.0 wt % of the graphite-containing layer. In some variations, the wt % of the combination of SBR and CMC is less than or equal to 7.0 wt % of the graphite-containing layer. In some variations, the wt % of the combination of SBR and CMC is less than or equal to 6.0 wt % of the graphite-containing layer. In some variations, the wt % of the combination of SBR and CMC is less than or equal to 5.0 wt % of the graphite-containing layer. In some variations, the wt % of the combination of SBR and CMC is less than or equal to 4.0 wt % of the graphite-containing layer. In some variations, the wt % of the combination of SBR and CMC is less than or equal to 3.0 wt % of the graphite-containing layer. In some variations, the wt % of the combination of SBR and CMC is less than or equal to 2.0 wt % of the graphite-containing layer.

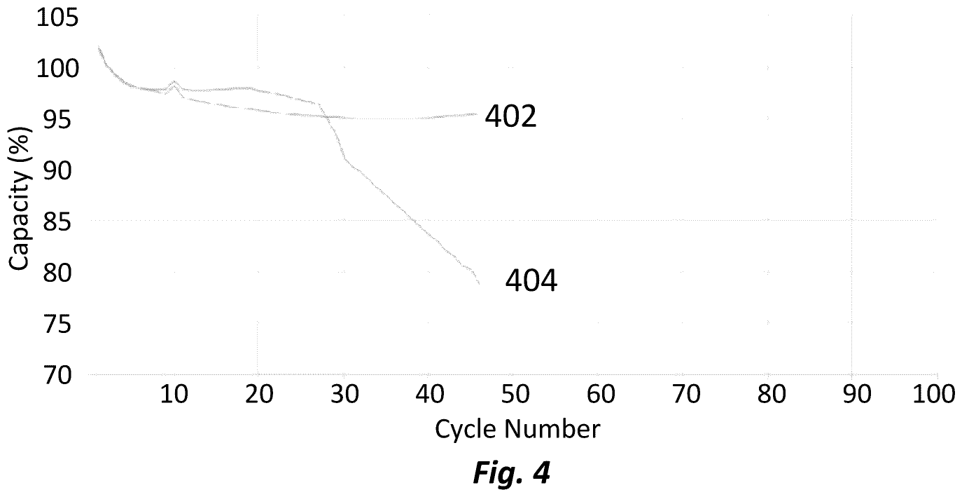

FIG. 4 depicts capacity as a function of battery cycle number for first battery 402, a battery cell with an anode similar to FIG. 3A (having a silicon-containing layer disposed on a copper foil substrate and a graphite-containing layer disposed on the silicon-containing layer). Specifically, the anode of battery 402 includes a first layer including 85.00 wt % silicon oxide, 9.80 wt % PU binder, 0.70 wt % binder CMC, additive 5.00 wt % SFG-6L, and 0.5 wt % SWCNT (single wall carbon nanotubes) disposed on copper foil substrate, and a second layer of 95.60 wt % graphite with 2.00 wt % SBR binder and 1.30 wt % CMC binder. The anode of second battery 404 includes a single layer combining both silicon oxide and graphite, including 94.21 wt % active material consisting of 20 wt % silicon oxide and 80 wt % graphite, 4.71 wt % of a combination of PU binder, SBR binder, and CMC binder, 0.14 wt % SWCNT, and 0.94 wt % Super P (carbon black). Batteries with both anode active materials maintained roughly the same capacity through 28 cycles. However, the battery with the silicon-containing layer and graphite-containing layer as the anode active material maintained capacity at cycle 28, through 46. The battery with a single layer of anode active material fell precipitously. The two layer anode active material resulted in substantially improved battery performance.

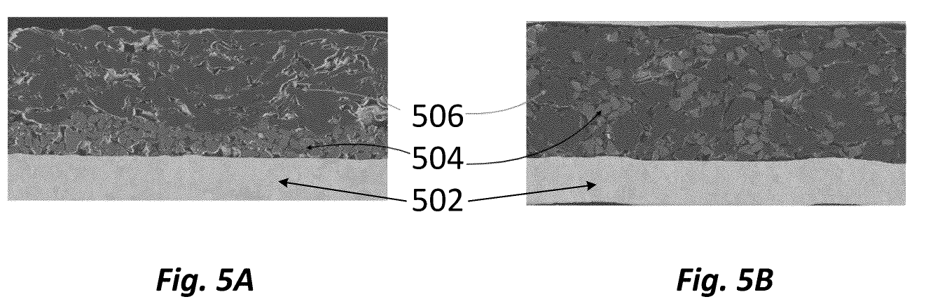

FIG. 5A depicts an SEM image of the layers depicted in FIG. 3A. The image shows a copper current collector 502, a first layer including silicon oxide 504 disposed on the copper current collector 502, and a second layer of graphite 506 disposed on the first layer including silicon oxide 504. FIG. 5B depicts an image of the single layer including both graphite and silicon oxide in FIG. 3B. The image shows a copper current collector 502, and a single layer that includes both graphite 506 and silicon oxide 504.

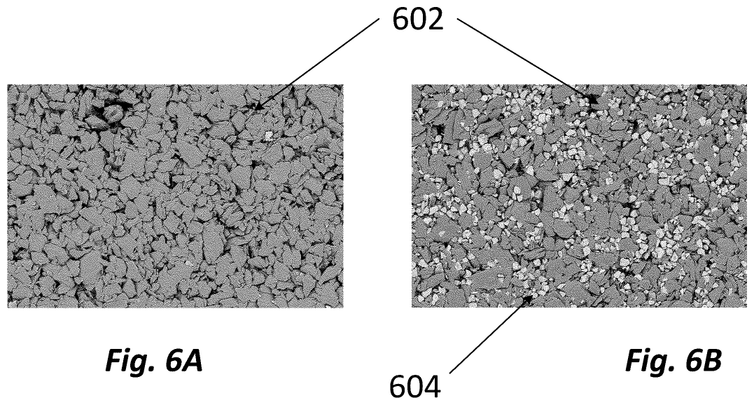

FIG. 6A depicts an SEM image of graphite-containing layer depicted in FIG. 3A lacking any silicon oxide. Specifically, only graphite 602 is visible in the image of the layer containing graphite. The image shows no silicon oxide particles. By contrast, FIG. 6B depicts an SEM image of the combined graphite and silicon oxide in a single layer, for example as depicted in FIG. 3B. Silicon oxide particles 604 are visible interspersed in graphite 602.

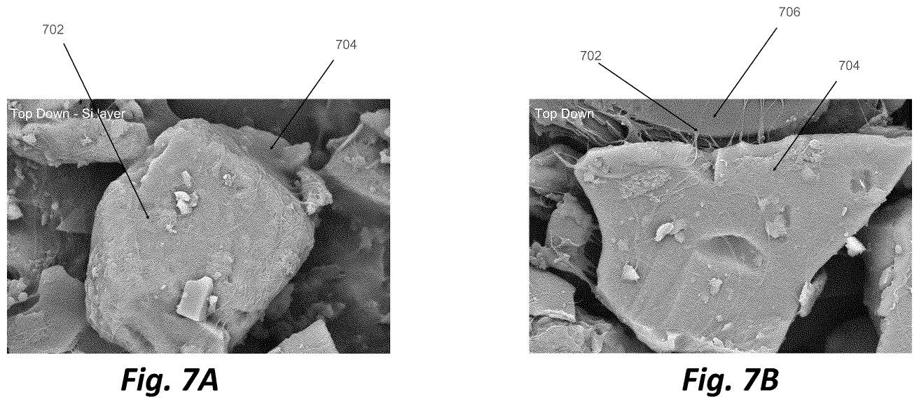

FIG. 7A depict CNT particles 702 and a silicon oxide particle 704 when silicon oxide and graphite are separated in two layers. In variations, the CNT is more effective when solely on the silicon-containing layer when same total amount CNT is added. FIG. 7B depict CNT particles 702 in a single layer of combined silicon oxide particle 704 and graphite 706. When silicon oxide and graphite were combined in a single layer, however, the CNT was shared between graphite and silicon oxide. The CNT particles coated both silicon oxide and graphite in the single layer, instead of only silicon oxide as in the two layer anode active material.

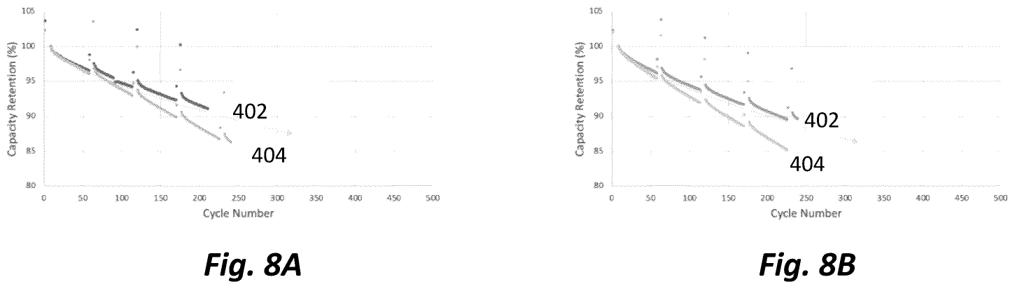

FIGS. 8A and 8B both show a comparison of capacity retention as a function of cycle count for the two layer anode active material with separate silicon- and graphite-containing layers, and the single layer anode active material. The anode active materials are the same as depicted in FIG. 4. In both FIGS. 8A and 8B, the capacity retention as a function of cycle count is higher for the two layer anode active material 402 than the single layer anode active material 404.

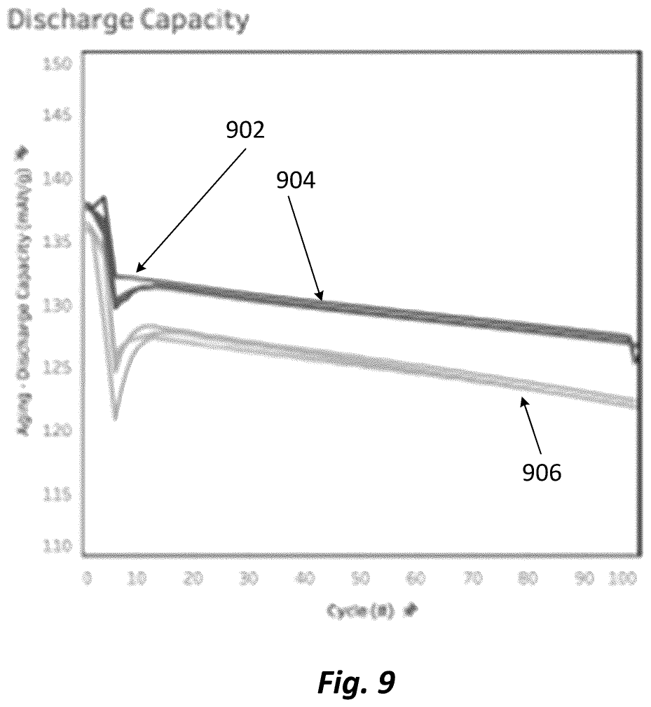

FIG. 9 shows the discharge capacity over various cycle counts for three batteries: battery 902 having with an anode having a first silicon-containing layer disposed on the anode and a second graphite-containing layer disposed on the silicon-containing layer, battery 904 having a silicon-containing layer only, and battery 906 having a graphite layer only. The result demonstrates that batteries with two anode layers show an improved electrochemical performance than batteries with single layer anodes.

The anodes described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An anode comprising:
an anode current collector,
a first layer disposed on the anode current collector, the first layer comprising silicon-containing active material; and
a second layer disposed on the first layer, the second layer comprising graphite.

2. The anode of claim 1, wherein the anode current collector comprises copper or nickel.

3. The anode of claim 1, wherein the first layer 5 wt %-60 wt % of the total wt % of the first layer and second layer.

4. The anode of claim 1, wherein the first layer is 10 wt %-30 wt % of the total wt % of the first layer and second layer.

5. The anode of claim 1, wherein the first layer is 15 wt %-25 wt % of the total wt % of the first layer and second layer.

6. The anode of claim 1, wherein the first layer comprises a first binder.

7. The anode of claim 6, wherein the first binder is selected from a Polyacrylic acid (PAA), a Polyimide (PI), a Polyvinylidene fluoride (PVdF), a Polyvinyl alcohol (PVA), a Polyacrylonitrile (PAN), a Polyethylene imine (PI), a polyurethane (PU), a derivative thereof, a copolymer thereof, and a combination thereof.

8. The anode of claim 7, wherein the first binder comprises a polyurethane or polyacrylic acid.

9. The anode of claim 8, wherein the first binder is a polyurethane.

10. The anode of claim 6, wherein the first layer comprises carboxy methylcellulose (CMC).

11. The anode of claim 1, wherein the first layer comprises a single-wall carbon nanotube, a multi-wall carbon nanotube, a vapor grown carbon fiber (VGCF), a graphite or a carbon black.

12. The anode of claim 6, wherein the first binder is in an amount of 5 wt %-20 wt % of the first layer.

13. The anode of claim 1, wherein the second layer comprises a second binder.

14. The anode of claim 13, wherein the second binder is in an amount from 1 wt % to 10 wt % of the second layer.

15. The anode of claim 13, wherein the second binder is selected from styrene-butadiene rubber (SBR), CMC, and a combination of both.

16. The anode of claim 13, wherein the second binder is a combination of SBR and CMC.

17. The anode of claim 15, wherein the SBR is in an amount from 0.5 wt %-5 wt %.

18. The anode of claim 15, wherein the CMC in an amount from 0.5 wt %-5 wt %.

19. The anode of claim 1, wherein the second layer comprises carbon black.

20. A battery cell comprising:
a cathode comprising a cathode active material disposed on a cathode current collector;
an anode according to claim 1;
a separator disposed between the cathode and anode; and
an electrolyte fluid disposed between the cathode and anode.
